(19) United States
(12) Patent Application Publication
(10) Pub. No.: US 2026/0037130 A1
(43) Pub. Date: Feb. 5, 2026

(54) MEMORY SYSTEM, MEMORY CONTROLLER AND METHOD OF OPERATING MEMORY SYSTEM

(71) Applicant: SK hynix Inc., Gyeonggi-do (KR)

(72) Inventor: Hyun Woo LEE, Gyeonggi-do (KR)

(21) Appl. No.: 19/056,760

(22) Filed: Feb. 19, 2025

(30) Foreign Application Priority Data
Aug. 5, 2024 (KR) 10-2024-0103538

(51) Int. Cl. G06F 3/06

(52) U.S. Cl. CPC G06F 3/0611; G06F 3/0647; G06F 3/0679

(57) ABSTRACT

Provided herein may be a memory system, a memory controller, and a method of operating the memory system. The memory system may include a memory device including a plurality of blocks, and a memory controller configured to determine a page type in which a data migration operation is to be performed based on an operating state of the memory device and a degradation type of a first block that is read among the plurality of blocks, and control the memory device to perform the data migration operation of migrating data of target pages to pages in a second block, the target pages determined based on the page type among multiple pages included in the first block.

### CROSS-REFERENCE TO RELATED APPLICATION

The present application claims priority under 35 U.S.C. § 119(a) to Korean patent application number 10-2024-0103538 filed on Aug. 5, 2024, the entire disclosure of which is incorporated herein by reference.

### BACKGROUND

### 1. Technical Field

Various embodiments of the present disclosure generally relate to a memory system for performing a read reclaim operation.

### 2. Related Art

Memory devices are classified into a volatile memory device and a nonvolatile memory device. The volatile memory device is a memory device in which data is stored only when power is supplied and in which stored data is lost when the supply of power is interrupted. The nonvolatile memory device is a memory device in which stored data is retained even when the supply of power is interrupted.

As the number of read operations in the memory device increases or as time elapses after storage of data, data stored in a NAND memory may be degraded. In order to prevent data degradation, a read reclaim operation may be performed. As the read reclaim operation is performed, operations performed on the memory device may be delayed.

### SUMMARY

Various embodiments of the present disclosure are directed to a memory system that can minimize a delay time by performing a migration operation on some of pages included in a read memory block depending on the degradation type of threshold voltage distributions of memory cells when a read reclaim operation of a memory system is performed.

An embodiment of the present disclosure may provide for a memory system. The memory system may include a memory device including a plurality of blocks, and a memory controller configured to determine a page type in which a data migration operation is to be performed based on an operating state of the memory device and a degradation type of a first block that is read among the plurality of blocks, and control the memory device to perform the data migration operation of migrating data of target pages to pages in a second block, the target pages determined based on the page type among multiple pages included in the first block.

An embodiment of the present disclosure may provide for a memory controller. The memory controller may include an error correction circuit configured to perform an error correction operation on data read from a first block included in a memory device, and a reclaim control circuit configured to determine a page type in which a data migration operation is to be performed among multiple pages included in the first block, based on an operating state of the memory device and a degradation type of the first block determined in response in failure in the error correction operation, and control the memory device to perform the data migration operation of migrating data of the target pages to pages in a second block.

An embodiment of the present disclosure may provide for a method of operating a memory system. The method may include determining an operating state of a memory device as a busy state or an idle state based on a power supply time of the memory device or a number of commands stored in a command queue, determining a degradation type of a first block included in the memory device based on a result of an error correction operation on data read from the first block, determining target pages on which a data migration operation is to be performed based on an operating state of the memory device and the degradation type of the first block, and performing the data migration operation of migrating data of the target pages to pages in a second block.

### BRIEF DESCRIPTION OF THE DRAWINGS

FIG. 1 is a diagram illustrating a memory system according to an embodiment of the present disclosure.

FIG. 2 is a diagram illustrating a data migration operation on some memory cells according to an embodiment of the present disclosure.

FIG. 3 is a diagram illustrating a memory cell array included in a memory device of FIG. 1.

FIG. 4 is a diagram illustrating program states of memory cells and MSB data, CSB data, and LSB data according to an embodiment of the present disclosure.

FIG. 5 is a diagram illustrating memory cells connected to the same word line according to an embodiment of the present disclosure.

FIG. 6 is a diagram illustrating a threshold voltage distribution corresponding to the lowest program state and the degradation type of a memory block according to an embodiment of the present disclosure.

FIG. 7 is a diagram illustrating a threshold voltage distribution corresponding to the highest program state and the degradation type of a memory block according to an embodiment of the present disclosure.

FIG. 8 is a flowchart illustrating a method of performing a read reclaim operation according to an embodiment of the present disclosure.

FIG. 9 is a flowchart illustrating a method of determining target memory cells for a data migration operation according to an embodiment of the present disclosure.

FIG. 10 is a diagram illustrating a data storage system including a memory system according to an embodiment of the present disclosure.

### DETAILED DESCRIPTION

Specific structural or functional descriptions in the embodiments of the present disclosure introduced in this specification are provided as examples to describe embodiments according to the concept of the present disclosure. The embodiments according to the concept of the present disclosure may be practiced in various forms, and should not be construed as being limited to the embodiments described in the specification.

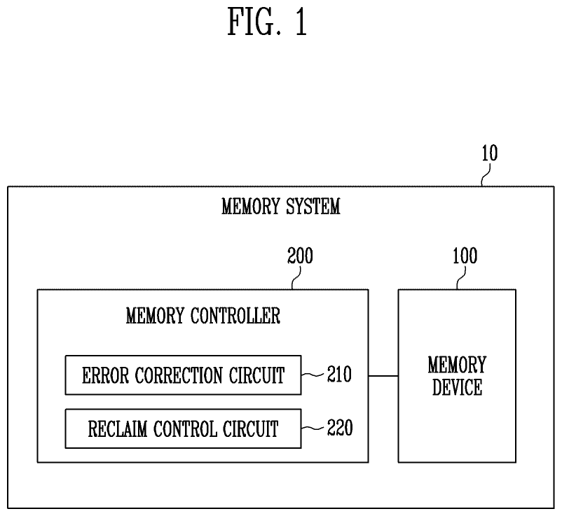

FIG. 1 is a diagram illustrating a memory system 10 according to an embodiment of the present disclosure.

Referring to FIG. 1, the memory system 10 may include a memory device 100 and a memory controller 200 which controls the operation of the memory device 100. The memory system 10 may store data under the control of a host device, such as a mobile phone, a smartphone, an MP3 player, a laptop computer, a desktop computer, a game console, a television (TV), a tablet PC, or an in-vehicle infotainment system.

The memory device 100 may store data. The memory device 100 may be operated in response to the control of the memory controller 200. The memory device 100 may include a memory cell array including a plurality of memory cells which store data.

The memory device 100 may receive a command and an address from the memory controller 200, and may access the area of the memory cell array, selected by the address. The memory device 100 may perform an operation indicated by the command on the area selected by the address. For example, the memory device 100 may perform a read operation, a program operation, or an erase operation on the plurality of memory cells.

The memory controller 200 may control the overall operation of the memory system 10. The memory controller 200 may control the memory device 100 to perform a program operation, a read operation or an erase operation in response to a request received from the host device. The memory controller 200 may control a background operation of the memory device 100. The background operation may include a wear leveling operation, a garbage collection operation, or a read reclaim operation. The memory controller 200 may generate a control signal for controlling the operation of the memory device 100.

The memory controller 200 may include an error correction circuit 210 and a reclaim control circuit 220. The memory controller 200 may count the number of read operations (i.e., read count) on the memory cells included in the memory device 100. The memory controller 200 may trigger the read reclaim operation on the memory device 100 based on the read count or the number of flipped bits. The flipped bits may indicate fail bits.

The error correction circuit 210 may perform an error correction encoding operation on data to be programmed to the memory device 100. The error correction circuit 210 may perform an error correction decoding operation based on the data read from the memory device 100, and may determine whether the error correction operation has passed or failed.

The error correction circuit 210 may count the number of fail bits among bits read from memory cells. The error correction circuit 210 may determine calibration read voltages based on read voltages corresponding to the program states of the memory cells and the result of the error correction operation.

The reclaim control circuit 220 may determine some pages among multiple pages included in the read memory block as target pages for a data migration operation in response to failure in the error correction operation. Data stored in the target pages for the data migration operation may be migrated to a memory block different from the read memory block. The reclaim control circuit 220 may determine the degradation type of the threshold voltage distribution of the memory cells based on the threshold voltage distribution. In an embodiment of the present disclosure, the degradation type of the threshold voltage distribution may be a read disturb type or a retention type.

The reclaim control circuit 220 may determine the target memory cells of data migration based on at least one of the number of on-cells corresponding to a read voltage for a program state, a calibration read voltage or the number of fail bits. In an embodiment of the present disclosure, even if the read count for the memory cells is less than a reclaim reference value at which the read reclaim operation is triggered, a data migration operation may be performed on target pages determined among pages included in the read memory block depending on the degradation type of the threshold voltage distribution, and may manage degradation of the threshold voltage distribution of the memory cells.

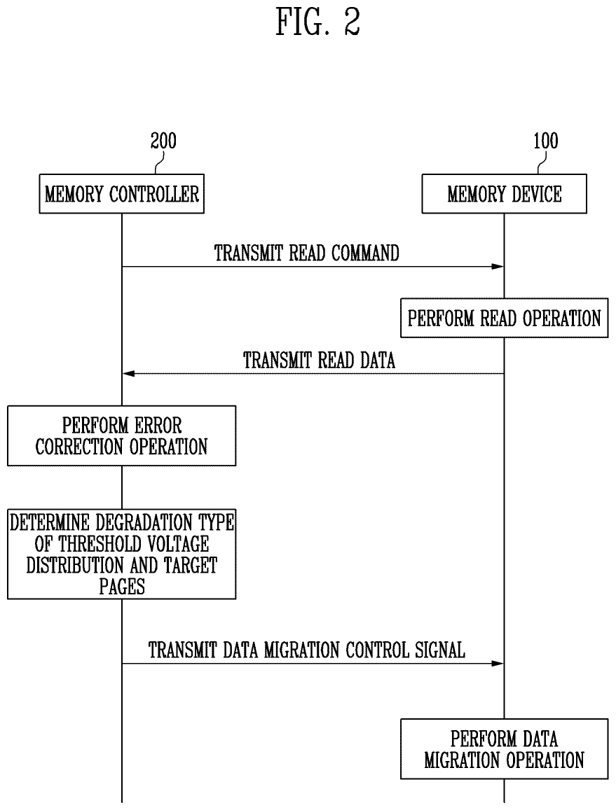

FIG. 2 is a diagram illustrating a data migration operation performed on some memory cells according to an embodiment of the present disclosure.

Referring to FIG. 2, the memory controller 200 may perform an error correction operation on read data received from a memory block included in the memory device 100. Further, the memory controller 200 may determine memory cells included in some pages among multiple pages included in the memory block as the target memory cells for a data migration operation depending on the degradation type of threshold voltage distribution of the memory cells.

The memory controller 200 may transmit a read command to the memory device 100. The read command may include an address indicating a position of the memory device 100 at which data is stored. The memory device 100 may perform, based on the read command, a read operation of reading data from the memory block. The memory device 100 may transfer the read data to the memory controller 200.

The memory controller 200 may perform an error correction operation on the read data. The memory controller 200 may determine the degradation type of the threshold voltage distribution of the memory cells and target memory cells for the data migration operation in response to failure in the error correction operation.

The memory controller 200 may determine the degradation type of the threshold voltage distribution of a read memory block based on at least one of a first threshold voltage distribution or a second threshold voltage distribution. The first threshold voltage distribution may correspond to the lowest program state in which a threshold voltage is the lowest, among the plurality of program states of the memory cells included in the read memory block. The second threshold voltage distribution may correspond to the highest program state in which a threshold voltage is the highest, among the plurality of program states of the memory cells included in the read memory block. The memory controller 200 may determine the degradation type of the memory block as a read disturb type in response to the case where the first threshold voltage distribution is greater than a first reference threshold voltage distribution corresponding to the lowest program state. The memory controller 200 may determine the degradation type of the memory block as a retention type in response to the case where the first threshold voltage distribution is less than the first reference threshold voltage distribution and the second threshold voltage distribution is less than a second reference threshold voltage distribution corresponding to the highest program state.

In an embodiment of the present disclosure, the memory controller 200 may count the number of on-cells corresponding to the read voltage for the program state. The memory controller 200 may determine the degradation type of the memory block as the read disturb type in response to the case where the number of on-cells corresponding to a first read voltage for the lowest program state is less than a first reference value. The memory controller 200 may determine the degradation type of the memory block as a retention type in response to the case where the number of on-cells corresponding to the first read voltage is greater than the first reference value and the number of on-cells corresponding to a second read voltage for the highest program state is greater than a second reference value.

In an embodiment of the present disclosure, the memory controller 200 may determine a first calibration read voltage corresponding to the first read voltage for the lowest program state based on the result of the error correction operation. The memory controller 200 may determine the degradation type of the memory block as the read disturb type in response to the case where the first calibration read voltage is greater than the first read voltage. The memory controller 200 may determine a second calibration read voltage corresponding to the second read voltage for the highest program state. The memory controller 200 may determine the degradation type of the memory block as a retention type in response to the case where the first calibration read voltage is less than the first read voltage and the second calibration read voltage is less than the second read voltage.

In an embodiment of the present disclosure, the memory block included in the memory device 100 may include a first page group in which most significant bit (MSB) data is stored, a second page group in which central significant bit (CSB) data is stored, and a third page group in which least significant bit (LSB) data is stored. The memory device 100 may count the number of fail bits in each of the first page group, the second page group, and the third page group which are included in the read memory block. The memory controller 200 may determine the degradation type of the memory block based on the page group having the largest number of fail bits, among the first page group, the second page group, and the third page group.

The memory controller 200 may determine the degradation type of the memory block as a read disturb type in response to the case where the first page group among the first page group, the second page group, and the third page group has the largest number of fail bits. The memory controller 200 may determine the degradation type of the memory block as a first retention type in response to the case where the second page group among the first page group, the second page group, and the third page group has the largest number of fail bits. The memory controller 200 may determine the degradation type of the memory block as a second retention type in response to the case where the third page group among the first page group, the second page group, and the third page group has the largest number of fail bits.

The memory controller 200 may determine pages included in the first page group as target pages for a data migration operation in response to the case where the degradation type of the memory block is the read disturb type. The memory controller 200 may generate a control signal for controlling the data migration operation to be performed on first memory cells and transmit the control signal to the memory device 100. The memory device 100 may perform the data migration operation on pages included in the first page group among the pages included in the read memory block. The cost of the data migration operation performed on the pages included in the first page group determined depending on the degradation type of the memory block is less than the cost of the data migration operation performed on all pages included in the read memory block. When the state of the memory device 100 is a busy state, a delay time attributable to a read reclaim operation may be reduced.

The memory controller 200 may determine pages included in the second page group as target pages for the data migration operation in response to the case where the degradation type of the memory block is the first retention type. The memory controller 200 may determine pages included in the third page group as target pages for the data migration operation in response to the case where the degradation type of the memory block is the second retention type. Similarly, the data migration operation is performed only on the pages included in the second page group or the third page group among the pages included in the read memory block, and thus the read reclaim operation of the memory device may be more quickly completed.

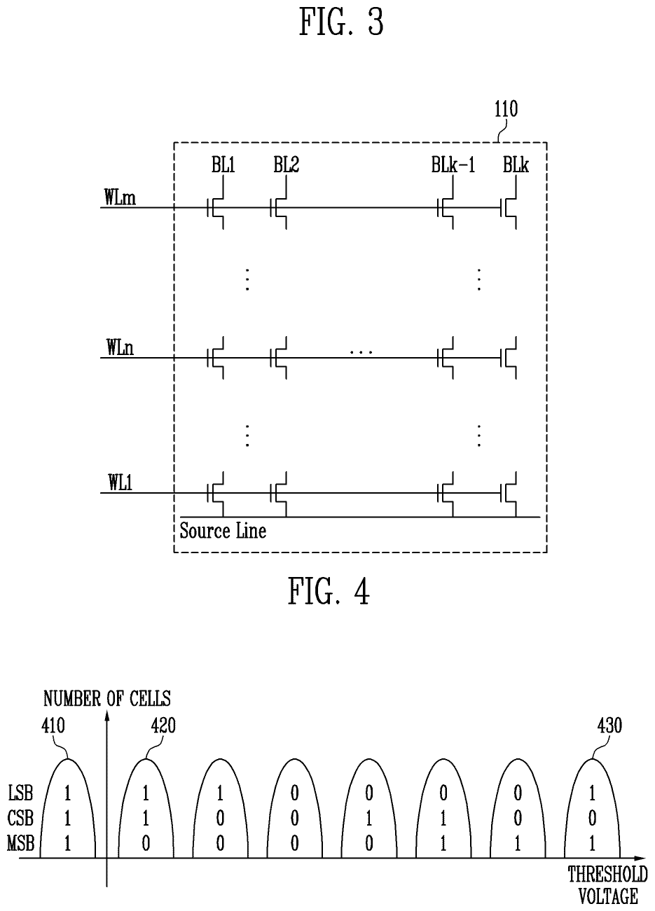

FIG. 3 is a diagram illustrating a memory cell array included in the memory device 100 of FIG. 1.

Referring to FIG. 3, a plurality of memory cells may be included in a memory cell array 110 of the memory device 100. In the illustrated example of FIG. 3, m memory cells are connected in series between a bit line and a source line, and gate terminals of k memory cells are connected to each other through the same word line.

Each of the memory cells included in the memory cell array 110 may be a single-level cell (SLC) which stores 1-bit data, or a memory cell which stores multi-bit data. The memory cell which stores the multi-bit data may be a multi-level cell (MLC) which stores 2-bit data, a triple-level cell (TLC) which stores 3-bit data, or a quad-level cell (QLC) which stores 4-bit data depending on the number of bits in the multi-bit data.

FIG. 4 is a diagram illustrating program states of memory cells and MSB data, CSB data, and LSB data according to an embodiment of the present disclosure.

Referring to FIG. 4, threshold voltage distributions corresponding to program states of TLC in which 3-bit data is stored in one memory cell may be illustrated. FIG. 4 shows threshold voltage distributions of an erase state 410 and a first program state 420 to a seventh program state 430. In the graph, a horizontal axis denotes threshold voltages, and a vertical axis denotes the number of memory cells.

Each of the memory cells may include MSB data, CSB data, and LSB data, and may be programmed to have a threshold voltage corresponding to any of the plurality of program states. For example, all bit values of the MSB data, CSB data, and LSB data of a memory cell in the erase state may be 1. Because the bit values of the MSB data, CSB data, and LSB data illustrated in FIG. 4 are only examples, they may be changed according to the embodiment.

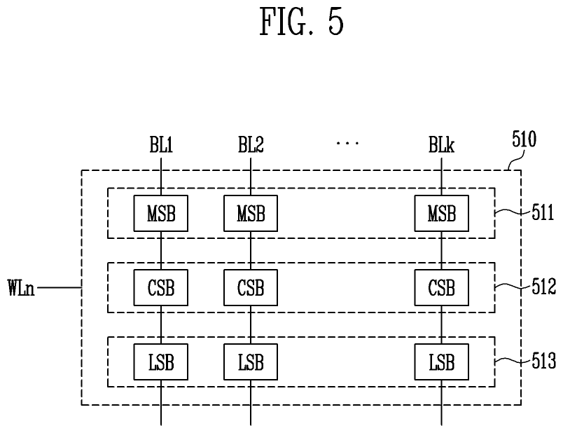

FIG. 5 is a diagram illustrating memory cells connected to the same word line according to an embodiment of the present disclosure.

Referring to FIG. 5, memory cells connected to an n-th word line WLn may be illustrated. Reference numeral 510 indicates k memory cells connected to the n-th word line WLn, and each of the memory cells includes MSB data, CSB data, and LSB data. The MSB data, the CSB data, and the LSB data included in one memory cell may be included in an MSB page, a CSB page, and an LSB page, respectively. The MSB pages which store the MSB data may be included in an MSB page group 511, the CSB pages which store the CSB data may be included in a CSB page group 512, and the LSB pages which store the LSB data may be included in an LSB page group 513.

When the memory cells connected to the n-th word line WLn are read, the MSB page group 511, the CSB page group 512, and the LSB page group 513 may be individually read. The memory controller 200 may determine the degradation type of the memory block including the memory cells connected to the n-th word line WLn based on the results of reading the MSB page group 511, the CSB page group 512, and the LSB page group 513. The memory controller 200 may control the memory device 100 to perform a data migration operation on target pages by determining one of the MSB pages, the CSB pages or the LSB pages, as the target pages for the data migration operation based on the degradation type of the memory block.

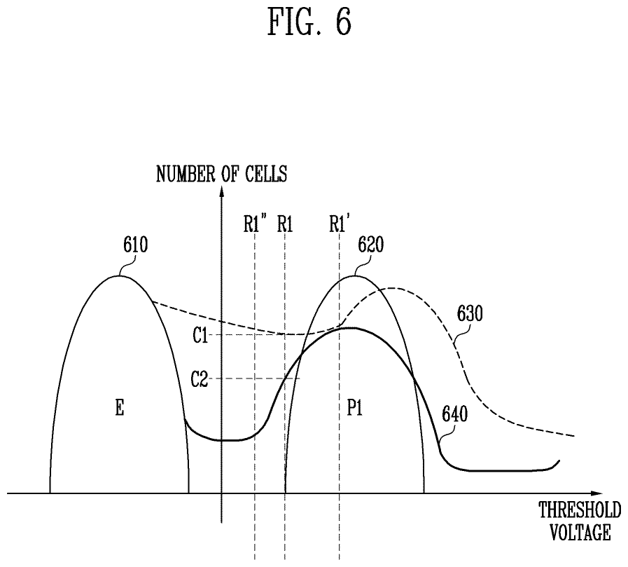

FIG. 6 is a diagram illustrating a threshold voltage distribution corresponding to the lowest program state and the degradation type of a memory block according to an embodiment of the present disclosure.

Referring to FIG. 6, the threshold voltage distributions of memory cells and degraded threshold voltage distributions may be illustrated for respective types. In FIG. 6, a horizontal axis may denote the threshold voltages, and a vertical axis may denote the number of memory cells. Reference numeral 610 indicates an ideal threshold voltage distribution corresponding to the erase state E of the memory cells. Reference numeral 620 indicates an ideal threshold voltage distribution corresponding to the lowest program state in which the threshold voltage of memory cells is the lowest among a plurality of program states. The lowest program state may be a first program state P1. Reference numeral 630 indicates a read disturb threshold voltage distribution in which the threshold voltages of memory cells corresponding to the erase state E and the lowest program state increase due to read disturb. Reference numeral 640 indicates a retention threshold voltage distribution in which the threshold voltages of memory cells corresponding to the plurality of program states decrease due to retention.

Due to read disturb, the threshold voltages of memory cells corresponding to the erase state E and a lowest program state may increase. As the threshold voltages increase, the threshold voltage distribution corresponding to the erase state E is widened or, alternatively, the threshold voltages of memory cells corresponding to the lowest program state increase. Thus, a curve indicated by reference numeral 630 may be shifted to the right in the graph compared to a curve indicated by reference numeral 620.

Due to retention, the threshold voltages of memory cells may entirely decrease. Retention may refer to a decrease in the number of electrons stored in floating gates of memory cells. The threshold voltages of the memory cells corresponding to the lowest program state decrease and are shifted to the left in the graph. The threshold voltage distribution for the erase state and the threshold voltage distribution for the lowest program state may overlap each other due to the memory cells, the threshold voltages of which decrease.

In an embodiment of the present disclosure, the memory controller 200 may determine the degradation type of the memory block by comparing the actual threshold voltage distribution corresponding to the first program state P1 with the ideal threshold voltage distribution 620. The memory controller 200 may count the number of on-cells corresponding to a first read voltage R1 for reading memory cells corresponding to the first program state P1. The memory controller 200 may compare the counted number of on-cells with a first reference value.

When read disturb occurs, the counted number of on-cells may be C1. When retention occurs, the counted number of on-cells may be C2. The memory controller 200 may set the first reference value to a value that is greater than C1 and less than C2. The memory controller 200 may determine the degradation type of the memory block as a read disturb type or a retention type based on the number of on-cells corresponding to the first read voltage R1.

In an embodiment of the present disclosure, the memory controller 200 may derive a first calibration read voltage, obtained by calibrating the first read voltage R1, based on the result of an error correction operation. In response to the occurrence of read disturb, the first read voltage R1 may be shifted to the right in the graph. The first calibration read voltage corresponding to the occurrence of read disturb may be R1′. In response to the occurrence of retention, the first read voltage R1 may be shifted to the left in the graph. The first calibration read voltage corresponding to the occurrence of retention may be R1″. The memory controller 200 may determine the degradation type of the memory block as the read disturb type in response to the case where the first calibration read voltage is greater than the first read voltage R1. The memory controller 200 may determine the degradation type of the memory block as the retention type in response to the case where the first calibration read voltage is less than the first read voltage R1.

In an embodiment of the present disclosure, the memory device 100 may count the number of first fail bits of a first page group in which MSB data is stored, the number of second fail bits of a second page group in which CSB data is stored, and the number of third fail bits of a third page group in which LSB data is stored, among pages included in the read memory block. The memory controller 200 may determine the degradation type of the memory block as the read disturb type in response to the case where the number of first fail bits, among the number of first fail bits, the number of second fail bits, and the number of third fail bits, is the largest. The memory controller 200 may determine the degradation type of the memory block as a first retention type in response to the case where the number of second fail bits is the largest. The memory controller 200 may determine the degradation type of the memory block as a second retention type in response to the case where the number of third fail bits is the largest.

In an embodiment of the present disclosure, the memory controller 200 may determine the degradation type of the memory block based on the number of on-cells corresponding to the first read voltage R1 and the number of fail bits. The memory controller 200 may determine the degradation type of the memory block as the read disturb type in response to the case where the number of on-cells is less than the first reference value and the number of first fail bits, among the number of first fail bits, the number of second fail bits, and the number of third fail bits, is the largest. The memory controller 200 may determine the degradation type of the memory block as the first retention type in response to the case where the number of on-cells is greater than the first reference value and the number of second fail bits is greater than the number of third fail bits. The memory controller 200 may determine the degradation type of the memory block as the second retention type in response to the case where the number of on-cells is greater than the first reference value and the number of second fail bits is less than or equal to the number of third fail bits.

The memory controller 200 may determine memory cells in pages included in the first page group as target memory cells for the data migration operation in response to the case where the degradation type of the memory block is the read disturb type. The memory controller 200 may determine memory cells in pages included in the second page group as target memory cells for the data migration operation in response to the case where the degradation type of the memory block is the first retention type. The memory controller 200 may determine memory cells in pages included in the third page group as target memory cells for the data migration operation in response to the case where the degradation type of the memory block is the second retention type. The memory controller 200 may determine memory cells in all pages included in the read memory block as target memory cells for the data migration operation in response to the case where the read count of the memory block is greater than a preset read reference value.

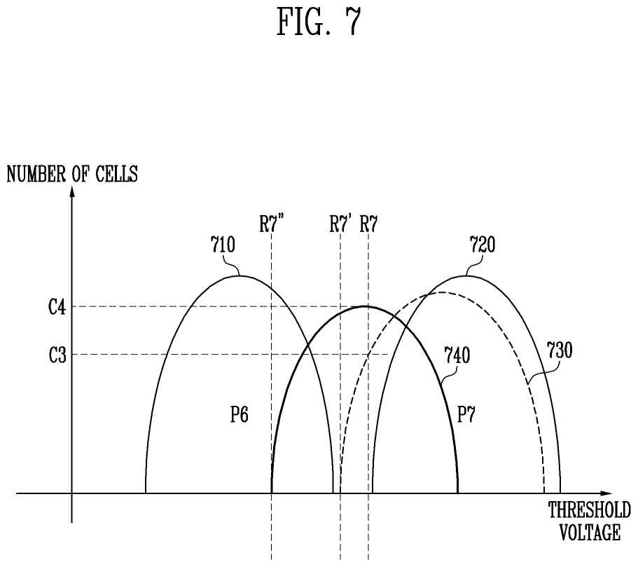

FIG. 7 is a diagram illustrating a threshold voltage distribution corresponding to the highest program state and the degradation type of a memory block according to an embodiment of the present disclosure.

Referring to FIG. 7, ideal threshold voltage distributions of memory cells and degraded threshold voltage distributions may be illustrated for respective types. In FIG. 7, a horizontal axis may denote threshold voltages, and a vertical axis may denote the number of memory cells. In FIG. 7, each memory cell may be a TLC. Reference numeral 710 indicates an ideal threshold voltage distribution corresponding to a sixth program state P6 among a plurality of program states. Reference numeral 720 indicates an ideal threshold voltage distribution corresponding to the highest program state in which the threshold voltage of memory cells is the highest among the plurality of program states. The highest program state may be a seventh program state P7. Reference numeral 730 indicates a threshold voltage distribution degraded due to read disturb. Reference numeral 740 indicates a retention threshold voltage distribution in which the threshold voltages of memory cells corresponding to the plurality of program states decrease due to retention.

The memory controller 200 may determine the degradation type of a threshold voltage distribution based on the number of first on-cells corresponding to a first read voltage R1 and the number of second on-cells corresponding to the seventh read voltage R7. The memory controller 200 may determine the degradation type of the memory block as a retention type in response to the case where the number of first on-cells corresponding to the first read voltage R1 is greater than a first reference value and the number of second on-cells corresponding to the seventh read voltage R7 is greater than a second reference value.

Among the degradation types of the memory block, the read disturb type may be determined using only the number of first on-cells corresponding to the first read voltage R1, but the retention type needs to be determined by additionally considering the number of second on-cells corresponding to the seventh read voltage R7. When read disturb occurs, the counted number of second on-cells may be C3. When retention occurs, the counted number of second on-cells may be C4. The memory controller 200 may set the second reference value to a value that is greater than C3 and less than C4.

In an embodiment of the present disclosure, the memory controller 200 may derive a seventh calibration read voltage, obtained by calibrating the seventh read voltage R7, based on the result of an error correction operation. Because the threshold voltages of memory cells corresponding to the seventh program state P7 decrease when read disturb and retention occur, the seventh read voltage R7 may be shifted to the left in the graph in response to the occurrence of read disturb and retention. The seventh calibration read voltage corresponding to the occurrence of read disturb in FIG. 7 may be R7′, and the seventh calibration read voltage corresponding to the occurrence of retention may be R7″. R7″ may be less than R7′. The memory controller 200 may determine the degradation type of the memory block as the retention type when the seventh calibration read voltage is R7″ that is lesser, and may determine the degradation type of the memory block as the read disturb type when the seventh calibration read voltage is R7′ that is greater.

The memory controller 200 may distinguish degradation of the first retention type from degradation of the second retention type based on the number of fail bits. The memory controller 200 may determine the degradation type as the first retention type in response to the case where the number of second fail bits is greater than the number of third fail bits, and may determine the degradation type as the second retention type in the opposite case.

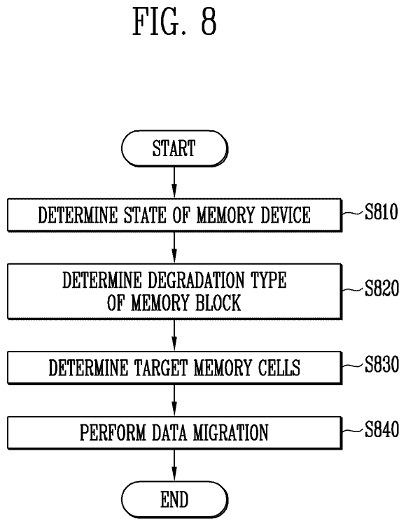

FIG. 8 is a flowchart illustrating a method of performing a read reclaim operation according to an embodiment of the present disclosure.

Referring to FIG. 8, a memory controller may control a memory device to perform a data migration operation on some of read memory cells in response to failure in an error correction operation. This may mitigate the degradation of threshold voltage distributions more quickly than that of a data migration operation performed on all pages included in a read memory block.

At S810, the memory controller may determine the operating state of the memory device as a busy state or an idle state based on the power supply time of the memory device or the number of commands stored in a command queue. The memory controller may determine the operating state of the memory device as the busy state in response to the case where the power supply time of the memory device is shorter than a reference time. The memory controller may determine the operating state of the memory device as the idle state in response to the case where the power supply time of the memory device is longer than or equal to the reference time.

In the command queue, commands instructing operations to be performed on the memory device may be stored. The memory controller may determine the operating state of the memory device as the busy state in response to the case where the number of commands stored in the command queue is greater than a reference count. The memory controller may determine the operating state of the memory device as the idle state in response to the case where the number of commands stored in the command queue is less than or equal to the reference count. In an embodiment of the present disclosure, the memory controller may determine the state of the memory device based on the number of read commands stored in the command queue. For example, the memory controller may determine the operating state of the memory device as the busy state when the number of read commands stored in the command queue is greater than or equal to the reference count.

At S820, the memory controller may determine the degradation type of a first block included in the memory device based on the result of an error correction operation on data read from the first block. The memory device may perform the error correction operation on the data read from the first block.

The memory controller may determine the degradation type of the first block as a read disturb type in response to the case where a first threshold voltage distribution corresponding to the lowest program state in which the threshold voltage of memory cells included in the first block is the lowest is greater than a first reference threshold voltage distribution corresponding to the lowest program state. The memory controller may determine the degradation type of the first block as a retention type in response to the case where the first threshold voltage distribution is less than the first reference threshold voltage distribution and a second threshold voltage distribution corresponding to the highest program state in which the threshold voltage is the highest is less than a second reference threshold voltage distribution corresponding to the highest program state.

In an embodiment of the present disclosure, the memory device may count the number of fail bits in each of a first page group, a second page group, and a third page group included in the first block, wherein MSB data is stored in the first page group, CSB data is stored in the second page group, and LSB data is stored in the third page group. The memory controller may determine the degradation type of the first block as a read disturb type in response to the case where the first page group, among the first page group, the second page group, and the third page group, has the largest number of fail bits. The memory controller may determine the degradation type of the first block as a first retention type in response to the case where the second page group, among the first page group, the second page group, and the third page group, has the largest number of fail bits. The memory controller may determine the degradation type of the first block as a second retention type in response to the case where the third page group, among the first page group, the second page group, and the third page group, has the largest number of fail bits.

At S830, the memory controller may determine target pages on which a data migration operation is to be performed based on the operating state of the memory device and the degradation type of the first block. The memory controller may determine the target pages as pages included in the first page group in response to the case where the operating state of the memory device is a busy state and the degradation type of the first block is a read disturb type. The memory controller may determine the target pages as pages included in the second page group in response to the case where the operating state of the memory device is a busy state and the degradation type of the first block is a first retention type. The memory controller may determine the target pages as pages included in the third page group in response to the case where the operating state of the memory device is a busy state and the degradation type of the first block is a second retention type. The memory controller may determine the target pages as all pages included in the first block in response to the case where the operating state of the memory device is an idle state.

At S840, the memory device may perform a data migration operation of migrating data included in the target pages to pages included in the second block. The memory controller may generate a control signal for performing the data migration operation.

Descriptions of respective operations of FIG. 8 may correspond to descriptions of FIGS. 1, 2, 6, and 7.

In an embodiment of the present disclosure, the memory controller may determine whether a data migration operation is to be performed on all pages included in the read memory block based on the state of the memory device. Further, the memory controller may determine target pages on which the data migration operation is to be performed among pages included in the read memory block based on the degradation type of the memory block. For example, the memory controller may determine pages included in the MSB page group as target pages for data migration when the memory device is in a busy state and the number of fail bits of the MSB page group in which MSB data is stored is the largest. The memory controller may control the memory device to perform the data migration operation on all pages included in the read memory block regardless of the degradation type of the read memory block when the memory device is in an idle state.

In an embodiment of the present disclosure, the memory controller may determine memory cells in some of the pages included in the read memory block as target memory cells for a data migration operation in response to the case where the memory system is performing a booting operation. The memory controller may determine that the memory device is performing a booting operation in response to the case where power supply time is shorter than a reference time. The memory controller may determine the state of the memory device as the busy state when the memory device is performing a booting operation. Because most of operations being performed during the booting operation are read operations, the degradation of the threshold voltage distribution of the memory block may be solved only by a data migration operation on some of the read memory cells.

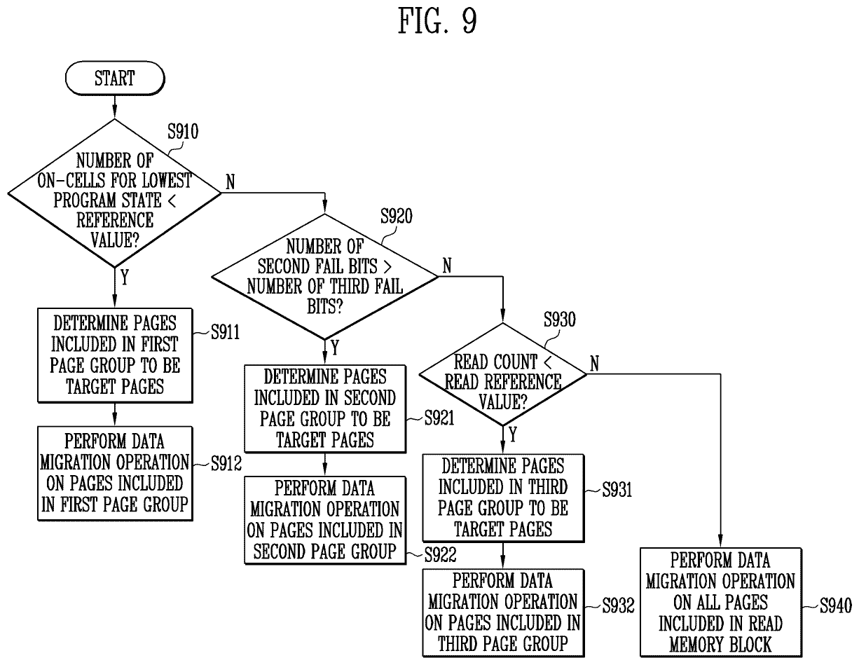

FIG. 9 is a flowchart illustrating a method of determining target memory cells for a data migration operation according to an embodiment of the present disclosure.

Referring to FIG. 9, the memory controller may determine target pages for a data migration operation based on the number of on-cells corresponding to a read voltage for the lowest program state and the number of fail bits. In FIG. 9, the memory device may be in a busy state.

At S910, the memory controller may compare the number of on-cells corresponding to the read voltage for the lowest program state with a reference value. When it is determined that the number of on-cells is less than the reference value (S910, Y), the memory controller may proceed to S911. When it is determined that the number of on-cells is greater than or equal to the reference value (S910, N), the memory controller may proceed to S920.

At S911, the memory controller may determine the degradation type of a read memory block as a read disturb type. The memory controller may determine memory cells in pages included in a first page group in which MSB data is stored as target memory cells for a data migration operation based on the read disturb type.

At S912, the memory controller may generate a control signal for the data migration operation on the pages included in the first page group. The memory device may perform a data migration operation on first memory cells among the read memory cells.

At S920, the memory controller may compare the number of second fail bits in pages included in a second page group in which CSB data is stored with the number of third fail bits in pages included in a third page group in which LSB data is stored. When it is determined that the number of second fail bits is greater than the number of third fail bits (S920, Y), the memory controller may proceed to S921. When it is determined that the number of second fail bits is less than or equal to the number of third fail bits (S920, N), the memory controller may proceed to S930.

At S921, the memory controller may determine the degradation type of the read memory block as a first retention type. The memory controller may determine memory cells in pages included in the second page group as target memory cells for the data migration operation based on the first retention type.

At S922, the memory controller may generate a control signal for a data migration operation on the pages included in the second page group. The memory device may perform a data migration operation on second memory cells among the read memory cells.

At S930, the memory controller may compare a read count for the read memory block with a read reference value. When it is determined that the read count is less than the read reference value (S930, Y), the memory controller may proceed to S931. When it is determined that the read count is greater than or equal to the read reference value (S930, N), the memory controller may proceed to S940.

At S931, the memory controller may determine the degradation type of the read memory block as a second retention type. The memory controller may determine memory cells in pages included in the third page group as target memory cells for the data migration operation based on the second retention type.

At S932, the memory controller may generate a control signal for a data migration operation on the pages included in the third page group. The memory device may perform a data migration operation on third memory cells among the read memory cells.

At S940, the memory controller may determine memory cells in all pages included in the read memory block as target memory cells for the data migration operation. When it is determined that the read count of the read memory block is greater than or equal to the read reference value even if the memory device is in a busy state, a data migration operation may be performed on all pages included in the read memory block.

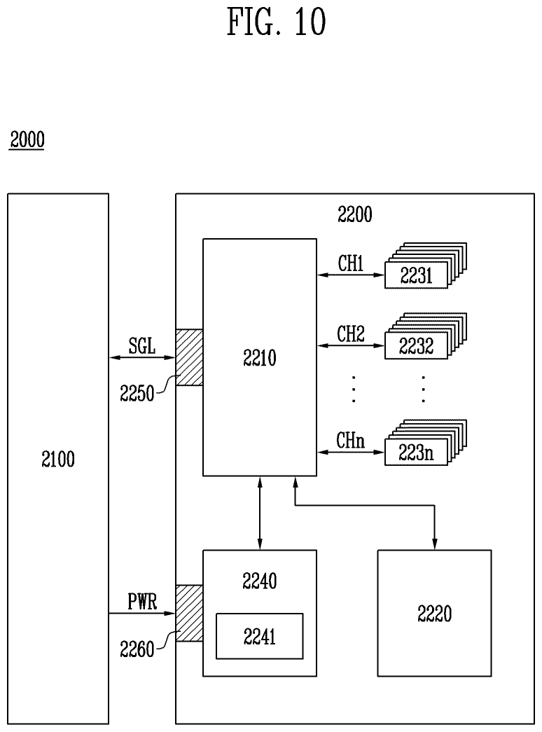

FIG. 10 is a diagram illustrating a data storage system including a memory system according to an embodiment of the present disclosure.

Referring to FIG. 10, a data storage system 2000 may include a host device 2100 and a solid state drive (SSD) 2200.

The SSD 2200 may include a controller 2210, a buffer memory device 2220, nonvolatile memories 2231 to 223n, a power supply 2240, a signal connector 2250, and a power connector 2260. The SSD 2200 may correspond to the memory system 10 described in FIGS. 1 to 9.

The buffer memory device 2220 may temporarily store data to be stored in the nonvolatile memories 2231 to 223n. Also, the buffer memory device 2220 may temporarily store data read from the nonvolatile memories 2231 to 223n. The data temporarily stored in the buffer memory device 2220 may be transmitted to the host device 2100 or the nonvolatile memories 2231 to 223n under the control of the controller 2210.

The nonvolatile memories 2231 to 223n may be used as storage media of the SSD 2200. The nonvolatile memories 2231 to 223n may be connected to the controller 2210 through a plurality of channels CH1 to CHn, respectively. One or more nonvolatile memories may be connected to one channel. The nonvolatile memories connected to one channel may be connected to the same signal bus and the same data bus.

The controller 2210 may control the overall operation of the SSD 2200. In an embodiment of the present disclosure, the controller 2210 may determine some of memory cells read by the SSD 2200 as target memory cells for a data migration operation. The controller 2210 may determine the degradation type of the threshold voltage distribution of memory cells in response to the case where an error correction operation on the read data fails, and may determine memory cells corresponding to the determined degradation type to be target memory cells. The controller 2210 may determine the degradation type and the target memory cells based on the number of on-cells corresponding to a read voltage for the lowest program state and the number of fail bits.

The power supply 2240 may provide power PWR received through the power connector 2260 into the SSD 2200. The power supply 2240 may include an auxiliary power supply 2241. When a sudden power-off occurs, the auxiliary power supply 2241 may supply power so that the SSD 2200 normally shuts off. The auxiliary power supply 2241 may include large-capacity capacitors capable of charging power PWR.

The controller 2210 may exchange a signal SGL with the host device 2100 through the signal connector 2250. The signal SGL may include a command, an address, data, etc. The signal connector 2250 may be implemented as various types of connectors depending on the interface scheme between the host device 2100 and the SSD 2200.

According to the embodiments of the present disclosure, there may be provided a memory system that can reduce the cost of performance of a migration operation by performing the migration operation on some pages depending on the degradation type of a threshold voltage distribution among pages included in a read memory block, thus minimizing a delay time.

The scope of the present disclosure is defined by the accompanying claims, rather than by the detailed description, and all modifications or changes derived from the meaning and scope of the claims and equivalents thereof should be construed as falling within the scope of the present disclosure. Furthermore, the embodiments may be combined to form additional embodiments.

What is claimed is:

1. A memory system, comprising:
a memory device including a plurality of blocks; and
a memory controller configured to:
determine a page type in which a data migration operation is to be performed based on an operating state of the memory device and a degradation type of a first block that is read among the plurality of blocks, and
control the memory device to perform the data migration operation of migrating data of target pages to pages in a second block, the target pages determined based on the page type among multiple pages included in the first block.

2. The memory system according to claim 1, wherein the memory controller is configured to determine the degradation type of the first block based on at least one of a first threshold voltage distribution or a second threshold voltage in response to a determination that the operating state of the memory device is a busy state and an error correction operation on data read from the first block fails, and
wherein the first threshold voltage distribution corresponds to a lowest program state in which a threshold voltage of memory cells included in the first block is lowest, and the second threshold voltage distribution corresponds to a highest program state in which the threshold voltage is highest.

3. The memory system according to claim 2, wherein the memory controller is configured to:
determine the degradation type of the first block as a read disturb type in response to a determination that the first threshold voltage distribution is greater than a first reference threshold voltage distribution corresponding to the lowest program state and
determine the degradation type of the first block as a retention type in response to a determination that the first threshold voltage distribution is less than the first reference threshold voltage distribution and the second threshold voltage distribution is less than a second reference threshold voltage distribution corresponding to the highest program state.

4. The memory system according to claim 3, wherein the memory controller is configured to determine the degradation type of the first block as the read disturb type in response to a determination that a number of on-cells corresponding to a first read voltage for the lowest program state is less than a first reference value.

5. The memory system according to claim 4, wherein the memory controller is configured to determine the degradation type of the first block as the retention type in response to a determination that the number of on-cells corresponding to the first read voltage is greater than the first reference value and the number of on-cells corresponding to a second read voltage for the highest program state is greater than a second reference value.

6. The memory system according to claim 3, wherein the memory controller is configured to determine a first calibration read voltage corresponding to a first read voltage for the lowest program state based on a result of the error correction operation, and to determine the degradation type of the first block as the read disturb type in response to a determination that the first calibration read voltage is greater than the first read voltage.

7. The memory system according to claim 6, wherein the memory controller is configured to determine a second calibration read voltage corresponding to a second read voltage for the highest program state based on the result of the error correction operation, and to determine the degradation type of the first block as the retention type in response to a determination that the first calibration read voltage is less than the first read voltage and the second calibration read voltage is less than the second read voltage.

8. The memory system according to claim 1, wherein:
the first block includes a first page group in which most significant bit (MSB) data is stored, a second page group in which central significant bit (CSB) data is stored, and a third page group in which least significant bit (LSB) data is stored,
the memory device counts a number of fail bits in each of the first page group, the second page group, and the third page group, and
the memory controller determines the degradation type of the first block as the read disturb type in response to a determination that the operating state of the memory device is a busy state and the first page group, among the first page group, the second page group, and the third page group, has a largest number of fail bits, and determines the target pages as pages included in the first page group in response to a determination that the degradation type of the first block is the read disturb type.

9. The memory system according to claim 8, wherein the memory controller is configured to determine the degradation type of the first block as a first retention type in response to a determination that the second page group, among the first page group, the second page group, and the third page group, has a largest number of fail bits, and to determine the target pages as pages included in the second page group in response to a determination that the degradation type of the first block is the first retention type.

10. The memory system according to claim 9, wherein the memory controller is configured to determine the degradation type of the first block as a second retention type in response to a determination that the third page group, among the first page group, the second page group, and the third page group, has a largest number of fail bits, and to determine the target pages as pages included in the third page group in response to a determination that the degradation type of the first block is the second retention type.

11. The memory system according to claim 10, wherein the memory controller is configured to determine the target pages as all pages included in the first block in response to a determination that the degradation type is the second retention type and a read count for the first block is greater than a preset read reference value.

12. The memory system according to claim 1, wherein the memory controller is configured to determine the operating state of the memory device as a busy state or an idle state based on a power supply time of the memory device or a number of commands that instruct operations to be performed on the memory device and that are stored in a command queue.

13. The memory system according to claim 12, wherein the memory controller is configured to determine the operating state of the memory device as the busy state in response to a determination that the power supply time of the memory device is shorter than a preset reference time.

14. The memory system according to claim 12, wherein the memory controller is configured to determine the operating state of the memory device as the busy state in response to a determination that the number of commands stored in the command queue is greater than a preset reference count.

15. The memory system according to claim 12, wherein the memory controller is configured to determine a part of the pages included in the first block as the target pages in response to a determination that the operating state of the memory device is determined to be the busy state.

16. The memory system according to claim 15, wherein the memory controller is configured to determine all pages included in the first block as the target pages in response to a determination that the operating state of the memory device is determined to be the idle state.

17. A memory controller comprising:
an error correction circuit configured to perform an error correction operation on data read from a first block included in a memory device; and
a reclaim control circuit configured to:
determine target pages in which a data migration operation is to be performed among multiple pages included in the first block, based on an operating state of the memory device and a degradation type of the first block determined in response to failure in the error correction operation, and
control the memory device to perform the data migration operation of migrating data of the target pages to pages in a second block.

18. The memory controller according to claim 17, wherein the reclaim control circuit is configured to determine an operating state of the memory device as a busy state or an idle state based on a power supply time of the memory device or a number of commands that instruct operations to be performed on the memory device and that are stored in a command queue.

19. The memory controller according to claim 17, wherein the reclaim control circuit is configured to determine the degradation type of the first block based on a threshold voltage distribution of memory cells included in the first block in response to a determination that the operating state of the memory device is a busy state and the error correction operation fails.

20. The memory controller according to claim 17, wherein the reclaim control circuit is configured to determine the page type based on a page group having a largest number of fail bits among a first page group, a second page group, and a third page group included in the first block, wherein most significant bit (MSB) data is stored in the first page group, central significant bit (CSB) data is stored in the second page group, and least significant bit (LSB) data is stored in the third page group.

21. A method of operating a memory system, the method comprising:
determining an operating state of a memory device as a busy state or an idle state based on a power supply time of the memory device or a number of commands stored in a command queue;
determining a degradation type of a first block included in the memory device based on a result of an error correction operation on data read from the first block;
determining target pages on which a data migration operation is to be performed based on an operating state of the memory device and the degradation type of the first block; and
performing the data migration operation of migrating data of the target pages to pages in a second block.

22. The method according to claim 21, wherein determining the degradation type of the first block comprises:
determining the degradation type of the first block as a read disturb type in response to a determination that a first threshold voltage distribution, corresponding to a lowest program state in which a threshold voltage of memory cells included in the first block is lowest, is greater than a first reference threshold voltage distribution corresponding to the lowest program state; and
determining the degradation type of the first block as a retention type in response to a determination that the first threshold voltage distribution is less than the first reference threshold voltage distribution and a second threshold voltage distribution, corresponding to a highest program state in which the threshold voltage is highest, is less than a second reference threshold voltage distribution corresponding to the highest program state.

23. The method according to claim 21, wherein determining the degradation type of the first block comprises:
counting a number of fail bits in each of a first page group, a second page group, and a third page group included in the first block, wherein most significant bit (MSB) data is stored in the first page group, central significant bit (CSB) data is stored in the second page group, and least significant bit (LSB) data is stored in the third page group;
determining the degradation type of the first block as a read disturb type in response to a determination that the first page group, among the first page group, the second page group, and the third page group, has a largest number of fail bits;
determining the degradation type of the first block as a first retention type in response to a determination that the second page group, among the first page group, the second page group, and the third page group, has a largest number of fail bits; and
determining the degradation type of the first block as a second retention type in response to a determination that the third page group, among the first page group, the second page group, and the third page group, has a largest number of fail bits.

24. The method according to claim 23, wherein determining the target pages further comprises:
determining the target pages as pages included in the first page group in response to a determination that the operating state of the memory device is a busy state and the degradation type of the first block is the read disturb type;
determining the target pages as pages included in the second page group in response to a determination that the operating state of the memory device is the busy state and the degradation type of the first block is the first retention type;
determining the target pages as pages included in the third page group in response to a determination that the operating state of the memory device is the busy state and the degradation type of the first block is the second retention type; and
determining the target pages as all pages included in the first block in response to a determination that the operating state of the memory device is an idle state.
